(19) United States
(12) Patent Application Publication
(10) Pub. No.: US 2010/0135873 A1
(43) Pub. Date: Jun. 3, 2010

(54) HONEYCOMB REACTORS WITH HIGH ASPECT RATIO CHANNELS

(76) Inventor: James Scott Sutherland, Corning, NY (US)

Correspondence Address: CORNING INCORPORATED, SP-TI-3-1, CORNING, NY, 14831, US

(21) Appl. No.: 12/624,905

(22) Filed: Nov. 24, 2009

Related U.S. Application Data
(60) Provisional application No. 61/118,654, filed on Nov. 30, 2008.

(51) Int. Cl. B01J 35/04; B28B 1/48; B28B 1/30

(52) U.S. Cl. 422/218; 264/138; 264/163

(57) ABSTRACT

Disclosed is a method of forming enclosed channels within a honeycomb including the steps of providing a honeycomb structure having cells divided by walls, the cells extending along a common direction from a first end to a second of the structure and removing selected walls of the honeycomb structure from one or both of the first and second ends of the structure, to a depth sufficient to reduce the original height of the selected walls by at least 50%. Also disclosed is a method of forming enclosed channels within a honeycomb structure includes removing selected walls of the honeycomb structure from one or both of the first and second ends of the structure, to a depth sufficient to completely removed the selected walls. Other methods and devices are also disclosed.

### PRIORITY

This application claims priority to U.S. Provisional Patent Application No. 61/118,654, filed Nov. 30, 2008, titled “Honeycomb Reactors With High Aspect Ratio Channels”.

### BACKGROUND

The present invention relates generally to honeycomb-body based reactors, more specifically to honey-comb body based reactors having high aspect ratio channels.

### SUMMARY

According to one aspect of the present invention, a method of forming enclosed channels within a honeycomb structure is presented including the steps of (1) providing a honeycomb structure having cells divided by walls, the cells extending along a common direction from a first end to a second of the structure and (2) removing selected walls of the honeycomb structure from one or both of the first and second ends of the structure, to a depth sufficient to reduce the original height of the selected walls by at least 50%. Desirably the height is reduced by 75% or even 90%.

According to another aspect of the present invention another method of forming enclosed channels within a honeycomb structure includes removing selected walls of the honeycomb structure from one or both of the first and second ends of the structure, to a depth sufficient to completely removed the selected walls.

According to yet another aspect of the present invention another method of forming enclosed channels within a honeycomb structure includes removing selected walls of the honeycomb structure from one or both of the first and second ends of the structure so as to form at least one channel, closing the at least one channel, where the selected walls are removed to a depth sufficient such that the formed channel, when closed, has an aspect ratio of 1:1 or greater, of height in the common direction to width, along 50% or greater of the channel path length, desirably 2:1 or greater, more desirably 4:1 or greater.

According to still another aspect of the present invention, a reactor or reactor component comprising a honeycomb body is provided, the honeycomb body having cells therein extending along a common direction, the body further having an enclosed channel defined therein extending across multiple cells of the body, the channel having at least one enclosed bend of 180 degrees therein.

According to yet another aspect of the present invention, a reactor or reactor component is provided, comprising a honeycomb body having cells divided by walls therein extending along a common direction, the body further having an enclosed channel defined therein extending across multiple cells of the body, the channel having residual walls of the cell walls of the reactor remaining therein, the residual walls comprising 50% or less of the length of the original walls, desirably 25% more desirably 10%.

### BRIEF DESCRIPTION OF THE DRAWINGS

FIGS. 1A-1C are plan views of one end of a honeycomb body 20 showing steps in a method of fowling a reactor or reactor component according to one aspect of the present invention.

FIG. 2 is a perspective view of a reactor or reactor component 12 according to, and fowled according to one aspect of the present invention.

FIG. 3 is a plan view of one end of a honeycomb body showing shims 30 useful according to another aspect of the present invention.

FIGS. 4A-4D are cross-sectional views of a honeycomb body 20 being processed according to still another aspect of the present invention.

FIGS. 5-7 are various other reactors or reactor components according to, and formed according to, additional aspects of the present invention.

### DETAILED DESCRIPTION

This Invention relates in general to techniques for fabricating honeycomb body based reactors having integrated fluidic passages, and in particular to reactors with high aspect ratio channels, and to methods for making reactors with high aspect ratio channels.

In previous work by the present inventor and colleagues, honeycomb body based reactors having long, high surface-to-volume ratio channels have been disclosed. For example, in PCT Publication No. WO2008/121390 entitled “Extruded Body Devices and Methods for Fluid Processing,” the present inventor and colleagues disclosed reactors having serpentine fluidic passages that follow successive ones, or successive groups, of cells of the honeycomb body, in a serpentine fashion, back and forth from one end of the honeycomb body to the other. While such devices provide very good thermal control—by means of heat exchange fluid flowing in the short open cells—and long dwell time for process fluids in the serpentine passages, the relatively small passage dimensions in the serpentine passages can result in significant pressure drop as flow rates are increased. Where reactant flow requires low pressure drop or very short residence time, the process fluids and the heat exchange fluids can be switched—process fluid can flow in the short straight open cells, while heat exchange fluid can flow through adjacent serpentine channels. But this results in large pressure drop along the heat exchange channel, especially when high heat exchange fluid flow rates are required to control extremely exothermic or endothermic reactions.

According to an aspect of the present invention, the pressure drop of internal fluidic paths—the paths through closed cells of a honeycomb body based reactor or reactor component—is reduced significantly by the use of high aspect ratio channels. High aspect ratio channel geometry provides a reduction in pressure drop for a given flow with only moderate reduction in heat exchange performance. According to another aspect of the present invention, a method of forming enclosed channels within a honeycomb structure is provided, including the steps of (1) providing a honeycomb structure having cells divided by walls, and (2) removing selected walls of the honeycomb structure from one or both of the first and second ends of the structure, to a depth sufficient to reduce the original height of the selected walls by at least 50%, desirably at least 75% or even 90%.

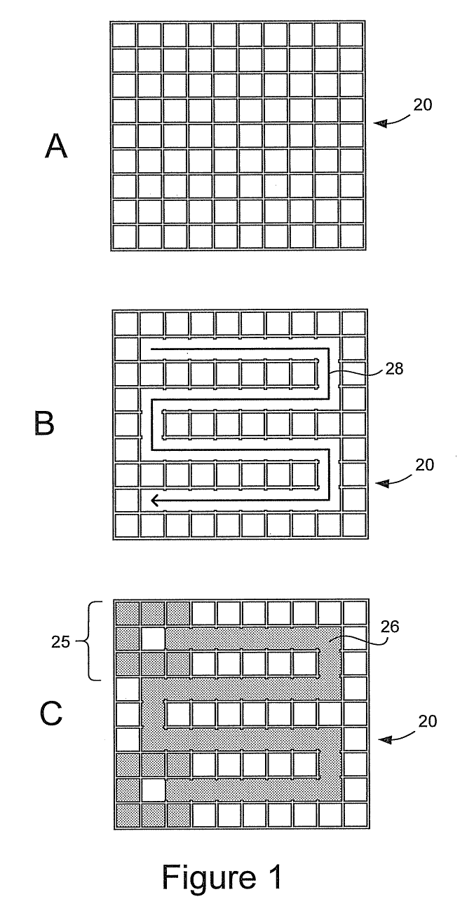

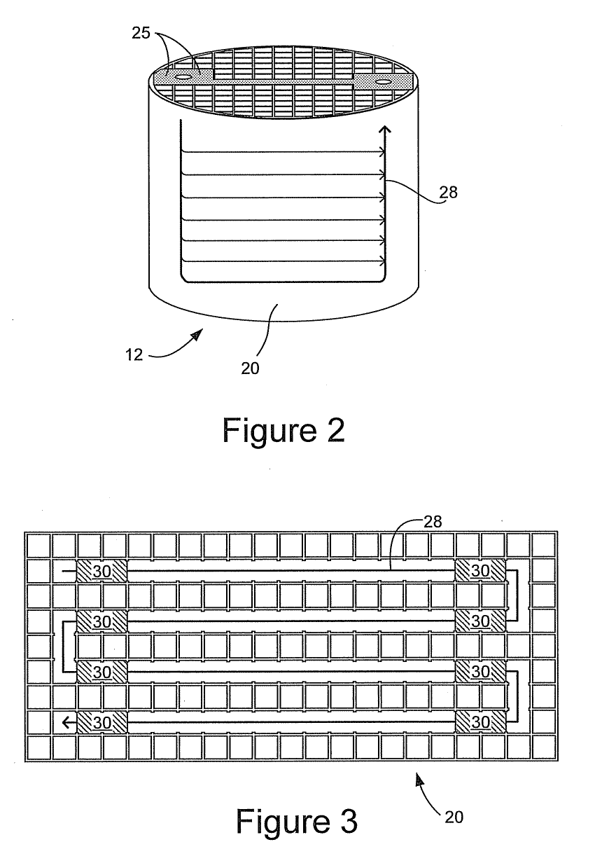

High aspect ratio fluid channels within cells closed at the end faces can be formed in a honeycomb body, according to the methods of the present invention, by any of various machining processes having sufficiently long and narrow reach, including but not limited to wire sawing, plunge-cut drilling, various laser cutting methods, and so forth. As shown in FIG. 1, according to one embodiment of the present invention, an extruded honeycomb body 20 is taken in the green state (FIG. 1A), then selected walls are removed completely to form a channel 28 (FIG. 1B), then the open ends are plugged with a plugging material 26 at the top and bottom, leaving a high-aspect ratio channel or passage enclosed within the extruded body 20 (FIG. 1C) and FIG. 2 (showing a straight channel). For ceramic, glass and glass-ceramic honeycomb bodies 20 that are machined in the green state, plugging may be in the green state or after firing. See the above-referenced PCT publication for information on materials that have been found suitable.

As another alternative according to the present invention, the channel or channels lying across the cell direction of the honeycomb cells can be created directly via extrusion through a custom die, effectively starting out at FIG. 1B, directly from extrusion.

As seen in FIG. 1C and FIG. 2, additional cells 25 of the honeycomb body 20 may be plugged around an opening into the passage, for supporting a fluid seal or the like. FIG. 2 shows a perspective view of a reactor 12 formed in a honeycomb body 20. The passage 28 has a high aspect ratio, being large in the height direction (the vertical direction in the figure) relative to the width direction (into the plane of the figure), desirably by at least 2:1 more desirably by at least 4:1 or more.

A potential challenge with the fabrication approaches of FIGS. 1A-1C, particularly where serpentine forms with long straight sections are used, is that during high temperature sintering channel walls can soften and deform. This channel wall sag deformation is significant problem for glass-based materials, and can also affect alumina based materials to some degree. Channel wall deformation leads to variation in channel width along the fluid path, inducing variation in fluid pressure drop. Wall deformation also causes channel width variation along the height direction of the high aspect ratio channel. This variation in fluid flow vertical position within the channel, leading to unwanted residence time dispersion.

As one solution to this potential challenge, according to another aspect of the present invention, small shims 30, shown in FIG. 3, can be inserted at selected locations in high aspect ratio reactant channel structures prior to sintering. During sintering the shims provide local support to channel wall structures, preventing sidewall sag deformation. The shims can be fabricated from the same material as the honeycomb body 20 itself. They can be fabricated to a predetermined size with precise thickness using molding or machining processes to ensure that a predetermined reactant channel width is maintained during sintering. The shims 30 are preferably significantly smaller than the height of the channel (the direction into the figure in FIG. 3), thus leaving a high aspect ratio open channel even with shims 30 present.

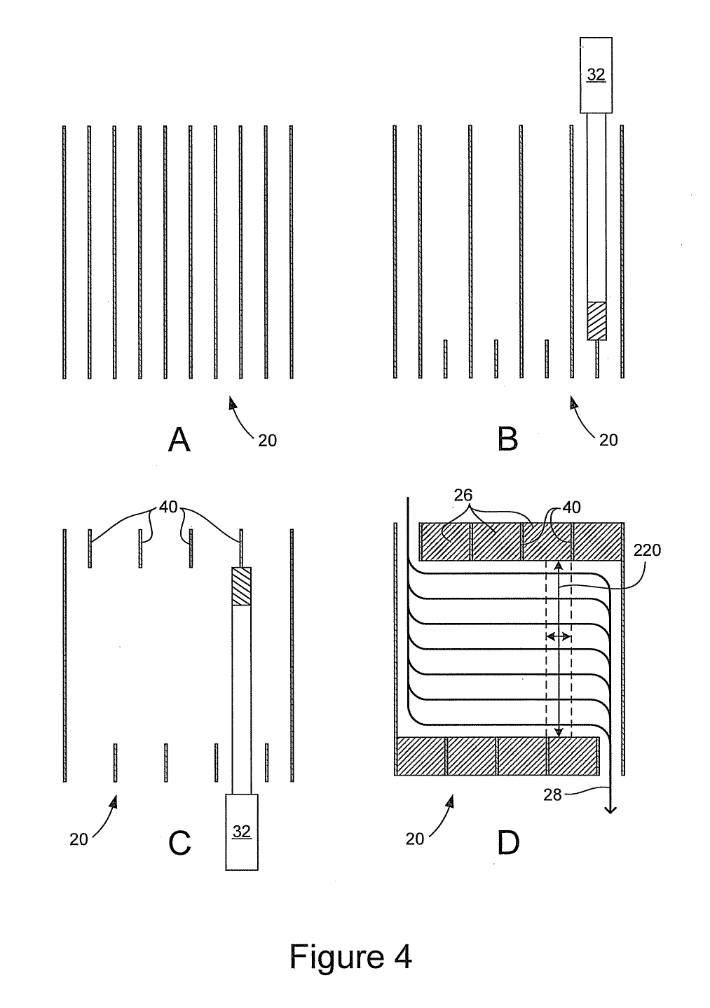

Another method of preserving channel geometry, according to yet another aspect of the present invention, is shown cross-sections of FIGS. 4A-4D. FIG. 4A shows a cross-sectional view of honeycomb cell walls before any processing. FIG. 4B shows how the walls are selectively machined by plunging almost completely though the walls with a cutting tool 32 from one end of the honeycomb, machining every other wall. As shown in FIG. 4C, the same machining operation is then carried out from the opposite end of the honeycomb, on the alternate walls along the particular channel. The high aspect ratio channel thus created is well supported during sintering by the wall sections 40 near the end face that remain after machining. FIG. 4D shows the completed high aspect ratio channel, with passage 28 formed therein by plugging with plug material 26. Assuming a square cell geometry in the honeycomb body 20, the aspect ratio achieved in this example, as indicated by the inset arrows, is about 7:1.

According to the method shown in FIGS. 4A-4D, enclosed channels within a honeycomb structure are formed by removing selected walls of the honeycomb structure from one or both of the first and second ends of the structure so as to form a channel, then closing the channel, where walls that farm the channel are removed to a depth sufficient such that the formed channel, when closed, has an aspect ratio of 1:1 or greater, of height to width, along 50% or greater of the channel path length. The aspect ratio is desirably 2:1 or greater, more desirably 4:1 or greater.

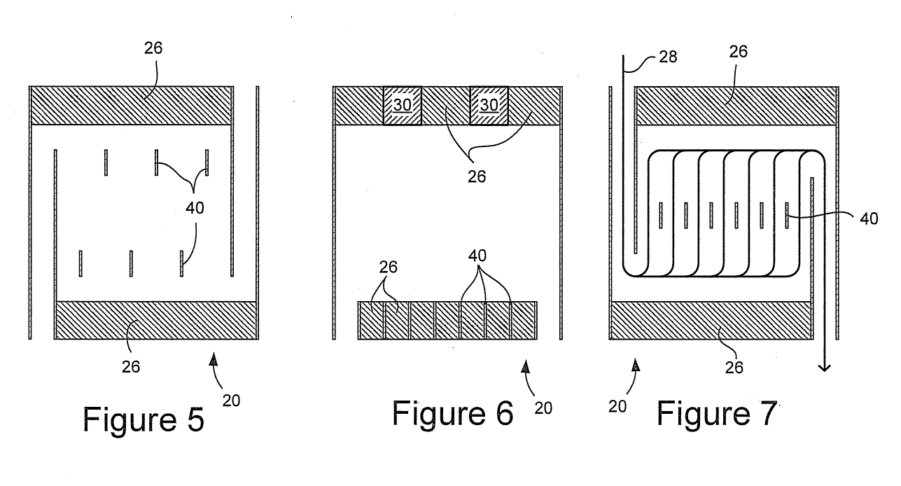

Additional embodiments produced by methods according to the present invention are shown in FIG. 5-7. In FIG. 5, remainders of walls have been left near but not at the end faces, allowing for a larger reactor depth in relation to maximum machining depth. In the embodiment of FIG. 6, walls have been completely removed except at one end of the body 20 only. In this case, optional shims 30 are used at the opposing side. In the embodiment of FIG. 7, small remaining walls, desirably only 10% or so of the original wall height, are left. Such small walls, left at the center, allows for the tallest reactor in relation to plunge machining depth.

In the embodiments of FIGS. 5 and 7, residual walls of the cell walls of the reactor remaining within the fluid passage(s) or channel(s) themselves. In such embodiments, the residual walls desirably comprise 50% or less of the length of the original walls, more desirably 25% or less, most desirably 10% or less.

The various methods of the present invention enable the manufacture of complex enclosed channels within honeycomb bodies. Unlike prior methods according to which any deep machining of honeycomb bodies was performed perpendicular to the cell direction, in the present invention machining in the same direction as the cells, using a narrow swath tool, allows the formation of complex serpentine shapes such as shown in FIGS. 1C and FIG. 3. The resulting reactors producible by these methods can include 180 degree turns within the internal closed passage. Accordingly, another aspect of the present invention is a reactor or reactor component comprising a honeycomb body having cells therein extending along a common direction, where the body also has an enclosed channel defined therein extending across multiple cells of the body, and the channel has at least one enclosed bend of 180 degrees.

What is claimed is:

1. Method of forming enclosed channels within a honeycomb structure, the method comprising:
providing honeycomb structure having cells divided by walls, the cells extending along a common direction from a first end to a second of the structure;
removing selected walls of the honeycomb structure from one or both of the first and second ends of the structure, to a depth sufficient to reduce the original height of the selected walls by at least 50%.

2. The method according to claim 1 wherein removing comprises reducing the original height of the selected walls by at least 75%

3. The method according to claim 1 wherein removing comprises reducing the original height of the selected walls by at least 90%.

4. The method of claim 1 wherein all selected walls are removed from a single side of the honeycomb structure.

5. The method of claim 1 wherein at least some of the selected walls are removed, at least in part, from both sides of the honeycomb structure.

6. The method of claim 1 wherein channels are fowled by the step of removing, and further comprising closing the resulting channels so as to produce enclosed channels having an aspect ratio of at least 1:1

7. The method of claim 6 wherein the aspect ratio is at least 2:1

8. The method of claim 6 wherein the aspect ratio is at least 4:1.

9. Method of forming enclosed channels within a honeycomb structure, the method comprising:
providing honeycomb structure having cells divided by walls, the cells extending along a common direction from a first end to a second of the structure;
removing selected walls of the honeycomb structure from one or both of the first and second ends of the structure, to a depth sufficient to completely remove the selected walls.

10. Method of forming enclosed channels within a honeycomb structure, the method comprising:
providing honeycomb structure having cells divided by walls, the cells extending along a common direction from a first end to a second of the structure;
removing selected walls of the honeycomb structure from one or both of the first and second ends of the structure so as to form at least one channel; and
closing the at least one channel,
wherein the step of removing selected walls includes removing the selected walls to a depth sufficient such that the formed channel, when closed, has an aspect ratio of 1:1 or greater, of height in the common direction to width, along 50% or greater of the channel path length.

11. The method of claim 6 wherein the aspect ratio is at least 2:1

12. The method of claim 6 wherein the aspect ratio is at least 4:1.

13. The method of claim 10 wherein the step of removing comprises removing at least 50% of the length of the selected walls.

14. The method of claim 10 wherein the step of removing comprises removing at least 75% of the length of the selected walls.

15. The method of claim 10 wherein the step of removing comprises removing at least 90% of the length of the selected walls.

16. A reactor or reactor component comprising a honeycomb body having cells therein extending along a common direction, the body further having an enclosed channel defined therein extending across multiple cells of the body, the channel having at least one enclosed bend of 180 degrees therein.

17. A reactor or reactor component comprising a honeycomb body having cells divided by walls therein extending along a common direction, the body further having an enclosed channel defined therein extending across multiple cells of the body, the channel having residual walls of the cell walls of the reactor remaining therein, the residual walls comprising 50% or less of the length of the original walls.

18. The reactor or reactor component of claim 17 wherein the residual walls comprise 75% or less of the length of the original walls.

19. The reactor or reactor component of claim 17 wherein the residual walls comprise 90% or less of the length of the original walls.
